(19) United States
(12) Patent Application Publication
(10) Pub. No.: US 2011/0159464 A1
(43) Pub. Date: Jun. 30, 2011

(54) SPHERICAL OBJECT PROVIDED WITH A MAP

(75) Inventor: David Sinclair, Westerham (GB)

(73) Assignee: GLOBEE LIMITED, Westerham (GB)

(21) Appl. No.: 12/650,620

(22) Filed: Dec. 31, 2009

(51) Int. Cl. G09B 27/08

(52) U.S. Cl. 434/146

(57) ABSTRACT

A spherical object is disclosed provided with a map substantial covering its entire surface wherein the map represents only a portion of the Earth such as a town, city, district, county, state or country. A label is also disclosed provided comprising a series of biconvex shapes which collectively describe such a map.

### BACKGROUND OF THE INVENTION

This invention relates to a spherical object provided with a map.

### SUMMARY OF INVENTION

In accordance with a first aspect of the present invention, there is provided a spherical object provided with a map substantially covering its entire surface wherein the map represents only a portion of the Earth

The inventor has realized that globe-like representation of a map is possible not only of the Earth itself but also, somewhat counter-intuitively, of portions of the Earth which themselves do not correspond to a spherical surface. For example, the map may be limited to a recognized geographic demarcation of an area of the Earth such as a town, city, district, county, state, country etc.

The map may represent an area bounded by respective different longitudes λ1, λ2 such that one half of a great circle of the sphere coincides with a mapping discontinuity on the sphere at which the map at its Eastern most latitude is adjacent the map at its Western most latitude.

Furthermore, where this is the case, map may be modified whereby the location and/or configuration of features adjacent the discontinuity are misrepresented so as to minimize the visual impact of the discontinuity.

The map may represent an area bounded by respective different latitudes φ1, φ2. Where this is the case, the map may be provided on the sphere whereby the mid-point latitude between latitudes φ1 and φ2 coincides with a great circle on the sphere. Also, the map may be scaled in the direction of latitude whereby the scaling is greater the further the distance in either longitudinal direction from a point of latitude in between latitudes φ1 and φ2 so as to fit the map on the sphere. As an alternative to this measure, the map may be is modified by omitting features of the map whereby more features are omitted the further the distance in either longitudinal direction from a point of latitude in between latitudes φ1 and φ2 so as to fit the map on the sphere.

The map also may represent an orthogonal area bounded by respective different longitudes λ1, λ2 and respective different latitudes φ1, φ2.

In accordance with a second aspect of the present invention, a label is provided comprising a series of biconvex shapes which collectively describe a map representing only a portion of the Earth. Ideally, the label is an adhesive label for sticking the shapes on to and thereby covering a spherical object in its entirety.

As with the spherical shape according to the first aspect of the present invention, the map may represent an area bounded by respective different latitudes φ1, φ2. Where this is the case, the scaling and modification described in the context of the spherical object above are equally applicable to a label for the same so as to fit the map within the concave shapes.

In addition, specific to the biconvex nature of the label shapes, the map may be modified whereby the longitude of at least one feature on the map is misrepresented compared to the actual longitude of that or those features so that or those features fit either within or centrally within a concave shape.

### BRIEF DESCRIPTION OF THE DRAWINGS

FIGS. 1a, 1b and 1c illustrate a spherical object according to the present invention on which a map of the city of London has been provided;

FIG. 2a shows the configuration of an adhesive label for applying to a blank spherical object to create the spherical objection as illustrated in FIGS. 1a, 1b and 1c;

FIG. 2b shows in greater detail a particular biconvex label shape of the label shown in FIG. 2a.

### DETAILED DESCRIPTION OF THE INVENTION

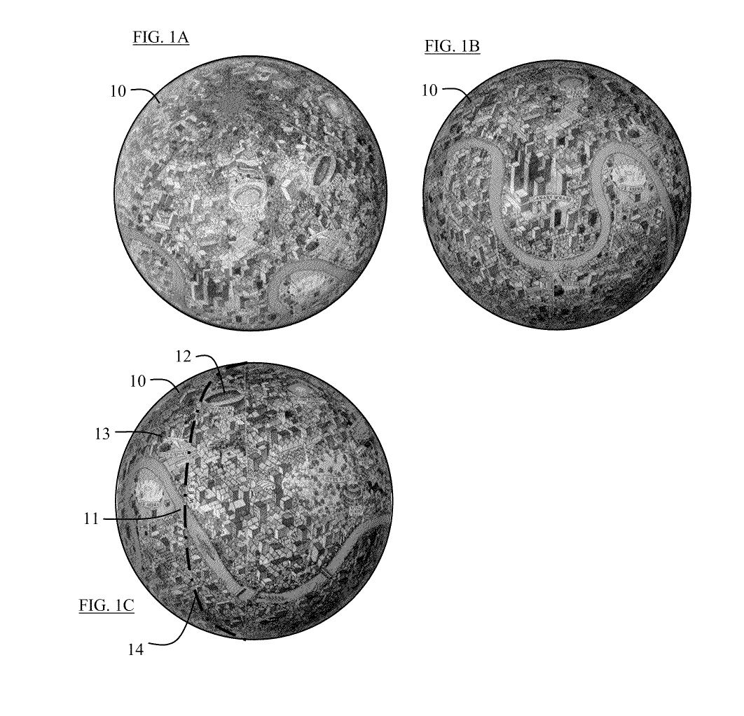

FIGS. 1a, 1b and 1c illustrate a spherical object 10 on which a map of the city of London has been provided.

The map represents an area bounded by respective different longitudes λ1, λ2. Specifically, with reference to FIG. 1c, the extends from a Western latitude just encompassing Wembley Stadium 12 to an Eastern latitude just encompassing City Airport 13. Inherently, therefore, the map has an East-West discontinuity 14 whereby the map at its Western most latitude is adjacent the map at its Eastern most latitude.

The map is schematic and modified whereby the location and/or configuration of features adjacent the discontinuity are misrepresented so as to minimize the visual impact of the discontinuity. In particular, the River Thames is presented as to appear a contiguous river over the East-West discontinuity 14.

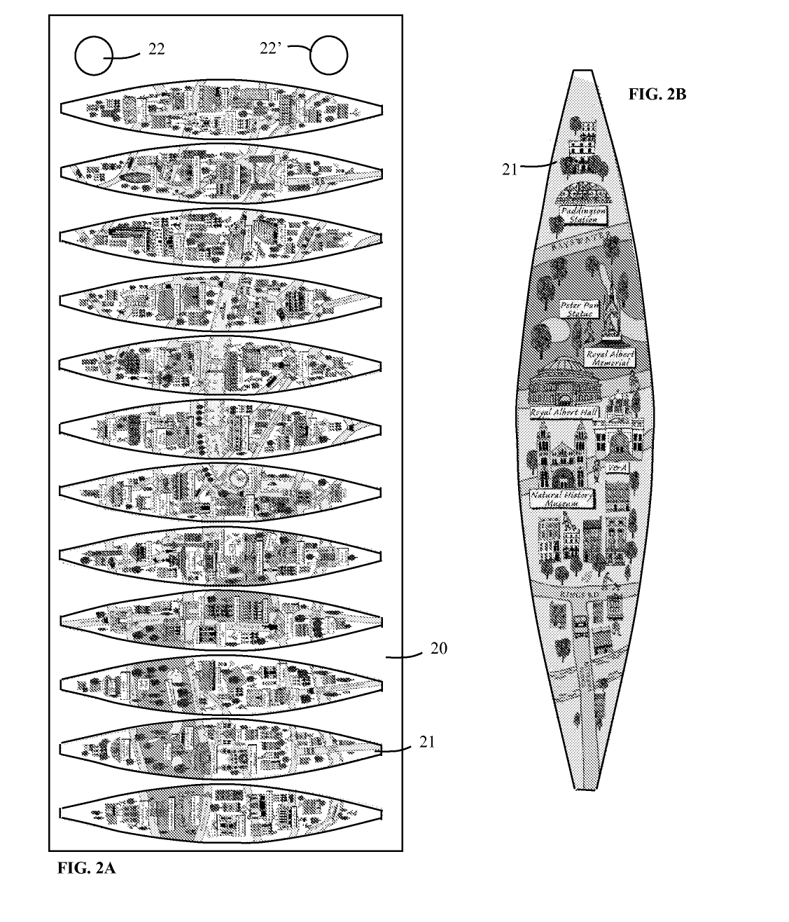

Referring to FIG. 2a, the configuration of an adhesive label 20 is shown for applying to a blank spherical object to create the spherical object 10 as illustrated in FIGS. 1a, 1b and 1c.

More specifically, the label 20 comprising a series of biconvex shapes 21 which collectively describe a map of London.

Inherently therefore, there is less scope for mapping detail the further the distance in either direction from the mid-point latitude if the map is to fit within the concave shapes. First, the map is scaled in the direction of latitude whereby the scaling is greater the further the distance in either direction from the mid-point latitude. Secondly, the map is modified by omitting features of the map whereby more features are omitted the further the distance in either longitudinal direction from the mid-point latitude.

Referring to FIG. 2B, one particular biconvex label shape 21 is shown in greater detail. In this shape, the map is modified whereby the longitude of Paddington Station is misrepresented compared to the actual longitude relative to the Royal Albert Hall on the same biconvex shape so that Paddington Station can be illustrated centrally within a concave shape.

Other variations on the above embodiments described will be apparent to those skilled in the art, without departing from the scope of the claims.

1. A spherical object provided with a map substantially covering its entire surface wherein the map represents only a portion of the Earth.

2. An object as claimed in claim 1 wherein the map represents an area bounded by respective different longitudes λ1, λ2 such that one half of a great circle of the sphere coincides with a mapping discontinuity on the sphere at which the map at its Eastern most latitude is adjacent the map at its Western most latitude.

3. An object as claimed in claim 2 wherein the map is modified whereby the location and/or configuration of features adjacent the discontinuity are misrepresented so as to minimize the visual impact of the discontinuity.

4. An object as claimed in claim 1 wherein the map represents an area bounded by respective different latitudes φ1, φ2.

5. An object as claimed in claim 4 wherein the map is provided on the sphere whereby the mid-point latitude between latitudes φ1 and φ2 coincides with a great circle on the sphere.

6. An object as claimed in claim 4 wherein the map is scaled in the direction of latitude whereby the scaling is greater the further the distance in either direction from a point of latitude in between latitudes φ1 and φ2 so as to fit the map on the sphere.

7. An object as claimed in claim 4 wherein the map is modified by omitting features of the map whereby more features are omitted the further the distance in either longitudinal direction from a point of latitude in between latitudes φ1 and φ2 so as to fit the map on the sphere.

8. An object as claimed in claim 1 wherein the map represents an orthogonal area bounded by respective different longitudes λ1, λ2 and respective different latitudes φ1, φ2.

9. An object as claimed in claim 1 wherein the map is representative of a town, city, district, county, state, country or other recognized geographic demarcation of an area of the Earth.

10. An label comprising a series of biconvex shapes which collectively describe a map representing only a portion of the Earth.

11. A label as claimed in claim 10 wherein the map wherein the map represents an area bounded by respective different latitudes φ1, φ2.

12. A label as claimed in claim 11 further comprising two circular shapes respectively describing areas of the map adjacent latitudes φ1, φ2.

13. A label as claimed in claim 11 wherein the map is scaled in the direction of latitude whereby the scaling is greater the further the distance in either direction from a point of latitude in between latitudes φ1 and φ2 so as to fit the map within the concave shapes.

14. A label as claimed in claim 11 wherein the map is modified by omitting features of the map whereby more features are omitted the further the distance in either longitudinal direction from a point of latitude in between latitudes φ1 and φ2 so as to fit the map within the concave shapes.

15. A label as claimed in claim 10 wherein the map is modified whereby the longitude of at least one feature on the map is misrepresented compared to the actual longitude of that or those features so that or those features fit either within or centrally within a concave shape.
